(19) United States
(12) Patent Application Publication
(10) Pub. No.: US 2010/0132973 A1
(43) Pub. Date: Jun. 3, 2010

(54) Electrical power cable with frangible insulation shield

(76) Inventors: Jonathan Gerald Fitz, West Columbia, SC (US); Jacob Ray Price, Gilbert, SC (US); Robert Stephen Caporale, Collierville, TN (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/308,752

(22) PCT Filed: Jun. 26, 2006
(86) PCT No.: PCT/US2006/024915

§ 371 Date: Dec. 7, 2009

(51) Int. Cl. H01B 9/02; H01B 7/00; H01R 43/00

(52) U.S. Cl. 174/102 R; 174/120 R; 29/825

(57) ABSTRACT

An electrical power cable has an insulation shield with at least one path of weakness along a length of the cable to facilitate stripping. When the path of weakness is a score or groove, a thickness of the insulation shield—between a bottom of the at least one groove and the outer surface of the underlying insulation layer is about 1-15 mils. Preferably, blades arranged around the circumference cable following extrusion of the insulation shield cut the at least one groove continuously into the shield along the cable's length. The at least one groove, or other means for imparting weakness, enables an installer to easily strip the insulation shield in the field with minimal use of specialized tools.

### TECHNICAL FIELD

The technical field of this invention relates to electrical power cables. More specifically, the technical field of the present invention relates to medium-voltage power cables having semiconducting insulation shields configured to improve their strippability for cable splicing or termination.

### BACKGROUND

Electrical power cables for distributing medium voltages (i.e. 5 kV to 46 kV) typically comprise several layers. These layers include an electrical conductor, an overlaying semiconductive shield, an insulation layer formed over the semiconductive shield, a semiconducting insulation shield over the insulation, a metallic shield, and an outermost protective jacket.

FIG. 1 shows an exemplary conventional cable 100. At its center, conductor 110 is typically made of copper, aluminum or aluminum alloy. Conductor 110 is either solid or stranded, with stranding adding flexibility to the cable. If stranded, the conductor often includes strand seal to fill its interstices, which helps prevent water migration along the conductor. Conductor shield 115, formed from a semiconductive material, surrounds-conductor 110.

Insulation 120 surrounds conductor shield 115 and is typically an extruded layer. Insulation 120 provides electrical insulation between conductor 110 and the closest electrical ground, thus preventing an electrical fault. Generally, insulation 120 is made of polyethylene, crosslinked polyethylene, or ethylene-propylene rubber. Insulation shield 125 surrounds insulation 120 and is usually made of an extruded semiconducting layer.

The term “core” is often used to indicate the combination of the conductor, conductor shield, insulation, and insulation shield of a power cable.

Optional jacket 130 provides thermal, mechanical, and environmental protection of the layers underneath it and often is constructed of polyethylene, PVC, polypropylene, or chlorinated polyethylene. Concentric neutrals 150 comprise a plurality of electrically conductive strands placed concentrically around insulation shield 125 and embedded within jacket 130. The concentric neutrals 150 serve as a neutral return current path to accommodate faults and must be sized accordingly. Alternative to concentric neutrals 150, a primary shield (not shown) may underlie jacket 130 and be made, for example, in the form of flat metal strips or a metal tape, possibly corrugated. The metal elements typically (i.e. concentric neutrals or the primary shield) need to have the capacity to carry high electrical currents (thousands of amperes) for a short duration (60 cycles/second or less) during an emergency condition until a relay system can interrupt the distribution system.

Concentric neutrals 150, insulation shield 125, and conductor shield 115 help control electrical stress, providing for more symmetry of the electric fields within cable 100. Polymeric semiconducting shields, such as insulation shield 125 and conductor shield 115, are often employed with cables rated for voltages greater than 2 kV. These shields provide layers of intermediate conductivity between the high potential conductor 110 and the primary insulation 120, and between the primary insulation 120 and the ground or neutral potential 150.

Splicing or terminating a power cable such as 100 requires the sequential removal of outer jacket 130, semiconductive insulation layer 125, and insulation 120. FIGS. 2A and 2B illustrate stages in stripping two medium-voltage cables for splicing. As shown in FIG. 2A, outer jacket 130 is first removed for a predetermined distance, exposing insulation shield 125. Concentric neutrals 150 are pulled back for later use after the splice. Also, insulation shield 125 is cut circumferentially or longitudinally at a predetermined distance from the end of the cable and that portion of insulation shield 125 is removed from the underlying insulation 120. As shown in FIG. 2B, a circumferential cut close to the end of the cable is then made through insulation 120 and conductor shield 115 (not shown). After this cut is made, a portion of insulation 120 and conductor shield 115 at the end of the cable are removed, exposing conductor 110 at the cable end. Similar steps are followed when preparing a single cable for termination.

Stripping a medium-voltage-cable can be challenging, particularly when performed in the field. For example, the various polymeric layers in the cable are moderately bonded together, making them difficult to separate when splicing or terminating the cable. The jacket and the insulation shield tend to stick together due to the affinity of polymeric (e.g. polyethylene) jackets to the class of materials normally employed as semiconducting insulation shields. Moreover, polymeric layers 115, 120, 125, and 130 are typically extruded under pressure during cable manufacture. Pressure extrusion causes the polymeric materials to fill interstitial areas between layers and the polymeric material (e.g. polyethylene) typically selected for such processing has a tendency to shrink-down after extrusion. The close formation and slight mechanical bond between layers helps avoid detrimental voids and minimizes any discharge that would otherwise occur, for instance, between the insulation layer and the semiconducting insulation shield. As a result, it typically takes between 3 and 24 lbs. of force (between about 13.3 and 107 N) to remove the insulation shield from its underlying insulation layer.

In addition, in stripping the semiconducting insulation shield of a medium-voltage cable, care must be taken to avoid nicking or cutting the underlying insulation layer which would result in the formation of electrical stress points inside the accessory body which is used for splicing or terminating the cable. As explained above, stripping a medium-voltage cable involves first removing the cable jacket for a predetermined distance from the end of the cable and then removing a length of the insulation shield. In cutting the insulation shield, the installer must be careful not to cut into the insulation layer because these cables operate under high electrical stress with as much as 50% of the maximum conductor operating stress being on the surface of the insulation. A cut passing through the insulation shield and into the insulation, even if only a fraction of a millimeter, can lead to partial discharge (ionization) at the cut after the splice or termination is complete.

Consequently, to splice or terminate a medium-voltage cable, an installer typically begins by scoring the insulation shield after removing the outer jacket. The score cuts through the surface of the insulation shield but preferably does not penetrate completely through the material to avoid nicking the underlying insulation layer. A small amount of the insulation shield material remains at the base of the score (generally about 5 mils (0.127 mm) or less). Using tools, installers typically create scores that pass longitudinally or helically along the cable from the cable's end to the predetermined distance from the end where the insulation shield needs to be removed. Once the insulation shield is scored, it can be peeled along the longitudinal or helical score marks to expose the insulation layer. To complete the stripping in the case of longitudinal or helical scores, the installer will peel back the strips to expose the insulation surface for a predetermined length. Performing this precise scoring in the field can be difficult.

U.S. Pat. Nos. 5,987,204 and 6,148,130 disclose signal-transmitting cables that are provided with predetermined discrete connectorization locations incorporated into the cable during manufacturing thereof. In detail, at least one pre-scored area is formed in the cable protective coating that surrounds the cable conductor during the cable manufacturing process to provide for ease of connectorization in the field. The user may apply force to break the protective coating at the prescored locations without using special tools to facilitate making connections. After breaking the coating along the prescored lines, the coating may be removed by sliding the protective coating along the cable as necessary.

U.S. Pat. No. 4,993,147 describes an automated method for cutting and stripping insulation without prescoring. One or more blades are moved in a predetermined manner with the respect to an insulated conductor held in a fixed position. The insulation is cut to a certain depth and thereafter severed and stripped from the cable.

Other documents disclose the use of release elements to improve the stripping of cables without specialized tools. For instance, U.S. Pat. No. 5,611,017 discloses a fiber optic ribbon cable comprising at least one release element periodically placed between the overall covering and the optical fibers to allow for easy access to the fibers. U.S. Pat. No. 5,008,490 is directed to electrically shielded, flat ribbon communication cables where a wire mesh material is placed under the electrical shield to make the shield easily removable.

U.S. Pat. No. 6,858,296 addresses specialized compositions for an overall insulation shield to improve its strippability while maintaining thermal stability.

Applicants have noted that none of the methods mentioned above resolve the problems posed in scoring and stripping insulation shields from medium-voltage cables due to the high electrical stresses inherent in such cables. Applicants have also noticed that existing designs do not provide an acceptable technique for peeling or stripping an insulation shield from a medium-voltage cable in the field at any point along the cable with minimal use of tools.

In particular, U.S. Pat. Nos. 5,987,204 and 6,148,130 cited above relate to signal transmitting cables, such as fiber optic cables or electrical cables, in which annular (i.e. circumferential) pre-scored areas of the cable protective coatings are provided for splicing and/or connectorization purposes without the need of stripping tools, said pre-scored areas being provided at predetermined intervals along the cable length.

The above mentioned annular scores are provided to the cable protective coating so that a portion thereof can be removed, said portion being caused to separate from the remaining cable by applying a traction force on said portion and thus causing the latter to slide over the cable core which is located in a radial inner position with respect to the cable covering.

Applicants have observed that the above mentioned annular scores cannot be effectively applied to the insulation shield of a medium-high voltage electrical cable at least for the following reasons.

First, the insulation shield of a medium-high voltage electrical cable requires to be firmly bonded to the underlying insulation layer. In fact, the presence of voids and consequently of entrapped air between the insulation layer and the insulation shield gives rise to the formation of partial discharges when the voltage stress exceeds the dielectric strength of air, said partial discharges harming the insulation layer due to ozone formation and causing premature failure of the cable. Therefore, since the insulation shield of a medium-high voltage cable needs to be bonded to the underlying insulation layer, the presence of annular scores provided in the insulation shield does not allow the latter to be removed by sliding over the insulation layer.

Second, due to the fact that a return current-(charging current or fault current) generally flows in the insulation shield of a medium-high voltage cable, the insulation shield cannot be provided with annular scenes, the presence of which would inhibit the return current from correctly flowing in the insulation shield.

Third, since the annular scores are provided at predetermined intervals along the cable length, problems would arise for the installer in selecting the proper dimensions for the cable preparation. For instance, in the case a splicing is carried out between two medium-high voltage-cables, the selected annular score should provide for a suitable length of the insulation layer to correctly receive a joint in the splicing area, said length varying, for instance, with respect to the cable diameter to be spliced.

Moreover, Applicants have noted that little accuracy is needed to provide the above-mentioned signal transmitting cables with annular scores. In fact, only the minimum score depth has to be controlled, as long as the protective coating can easily separate and the conductor is not cut or damaged. Applicants have observed that, since low voltages are involved, the electrical stress is very small and of little concern to pre-scoring.

U.S. Pat. Nos. 5,611,017 and 5,008,490 disclose release elements that are placed under the shield or cover, in direct or close-contact with the cable or fiber, in order to easily access the conductor or the fibers for terminating purposes. The Applicants have observed that, since these cables operate at very low voltages, the release elements do not generate any electrical problem to the cables. On the contrary, where medium-high voltage-cables are considered, any material placed between the insulation and insulation shield would be a potential source for the initiation of partial discharge during operation, leading to early and premature failure of the cables.

### SUMMARY

Applicants have perceived the heed for providing a medium-high voltage power cable that allows easy removal of the cable insulation shield during cable preparation and installation without the need for specific tools to be carefully operated in the field by skilled technical personnel to make very thin cuts without causing any damage to the underlying cable insulation layer.

Applicants have found that the above mentioned problems can be satisfactorily solved by providing the cable insulation shield with at least one path of weakness that is located longitudinally along the cable length in order to facilitate longitudinal stripping of the cable insulation shield.

Therefore, consistent with the principles of the present invention, an electrical power cable includes a core having at least one conductive element, a semiconducting conductor shield surrounding the core, an insulation layer surrounding the conductor shield and having an outer surface, an insulation shield surrounding the insulation layer and contacting the outer surface and a jacket surrounding the insulation shield. The insulation shield has at least one path of weakness along a length of the cable configured to facilitate longitudinal stripping of the insulation shield, and the jacket surrounds the insulation shield.

According to the principles of the present invention, the term “insulation shield” or “outer semiconductive layer” is used to identify a cable polymeric layer that surrounds and contacts the cable insulation layer. The polymeric layer is firmly bonded to the insulation layer and preferably obtained by extrusion. Preferably, the base polymeric material comprises an electroconductive carbon black, which makes the insulation shield electrically conductive. Preferably, the base polymeric material is a non-crosslinked polymeric material, e.g. a polypropylene compound. Preferably, the amount of carbon black is chosen to provide the insulation shield with a volumetric resistivity value, at room temperature, of less than 500 Ωm, preferably less than 20 Ωm.

The at least one path of weakness may extend continuously along the entire length of the cable. In one embodiment, the path is substantially straight and parallel to the axis of the cable. In another embodiment, the path is substantially helical around the axis of the cable.

In one aspect, the at least one path of weakness is a groove or score line in the insulation shield. The thickness of the insulation shield between the bottom of the at least one groove and the outer surface of the insulation layer is about 1-15 mils (about 0.025-0.381 mm), preferably about 5-10 mils (about 0.127-0.254 mm).

In another aspect, the at least one path of weakness is one of a ripcord and a release element embedded in the insulation shield. A release element may include a tape or other material dissimilar to the material of the insulation shield that is co-extruded along the path of weakness with the insulation shield during manufacture.

Also consistent with the principles of the present invention, a method for producing an electrical power cable having improved strippability includes providing a cable core with at least one conductive element, applying a semiconducting conductor shield around the core, providing an insulation layer around the conductor shield, extruding an insulation shield around the insulation layer, imparting a path of weakness within the insulation shield along a length of the cable, and extruding an outer jacket over the scored insulation shield. Applying the semiconducting conductor shield, providing the insulation layer, and extruding the insulation shield may be performed simultaneously through co-extrusion.

In one aspect, imparting a path of weakness within the insulation shield involves scoring the insulation shield to a depth of about 1-15 mils (about 0.025-0.381 mm) radially above the insulation layer. Preferably, the scoring occurs to a depth of about 5-10 mils above the insulation layer (about 0.127-0.254 mm).

Scoring the insulation shield may involve moving the cable longitudinally, before extrusion of the jacket, through at least one blade positioned to cut into an exterior surface of the insulation shield. Two blades may be arranged substantially in parallel to each other or at an angle to each other to improve the strippability of the insulation shield. Alternatively, blades may be rotated around the circumference of the cable to impart a spiral or helical groove into the surface of the insulation shield.

Alternatively, imparting at least one path of weakness may involve co-extruding other materials into the insulation shield layer. Co-extruded materials may include those having a material strength dissimilar to the insulation shield or ripcords embedded within the insulation shield.

It is to be understood that both the foregoing general description and the following detailed description are exemplary and explanatory only and are not restrictive of the invention as claimed. The foregoing background and summary are not intended to provide any independent limitations on the claimed invention.

### BRIEF DESCRIPTION OF THE DRAWINGS

The accompanying drawings, which are incorporated herein and constitute a part of this specification, illustrate several embodiments of the invention, and together with the description, serve to explain the principles of the invention.

FIG. 1 is a longitudinal perspective of a conventional electrical power cable.

FIG. 2A is a side view of two conventional electrical power cables in a first stage of being spliced.

FIG. 2B is a side view of two conventional electrical power cables in a second stage of being spliced

FIG. 3 is a longitudinal perspective of an electrical power cable having straight paths of weakness consistent with an embodiment of the present invention.

FIG. 4 is a longitudinal perspective of an electrical power cable having helical paths of weakness consistent with another embodiment of the present invention

FIG. 5 is a flowchart depicting steps in manufacturing an electrical power cable consistent with the principles of the present invention.

FIG. 6A is a cross-sectional diagram of a parallel orientation of blades for producing grooves in an insulation shield of the electrical power cable of FIG. 3 or 4.

FIG. 6B is a cross-sectional diagram of an angled orientation of blades for producing grooves in an insulation shield of the electrical power cable of FIG. 3 or 4.

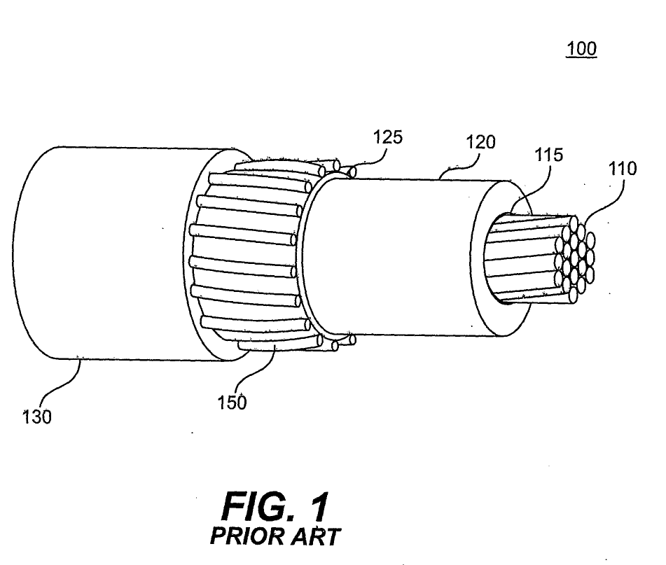

### DETAILED DESCRIPTION

The following detailed description refers to the accompanying, drawings. Wherever possible, the same reference numbers are used in the drawings and the following description to refer to the same or similar parts. While several exemplary versions and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding stages to the disclosed methods. Accordingly, the following detailed description does not limit the invention. Instead, the proper scope of the invention is defined by the appended claims.

Consistent with the principles of the present invention, an electrical power cable includes a cable core having at least one conductive element, a semiconducting conductor shield surrounding the core, an insulation layer surrounding the conductor shield and having an outer surface, an insulation shield surrounding the insulation layer and contacting the outer surface. In a position radially external to the cable core, the cable is provided with a metallic shield and an outer jacket. The insulation shield includes at least one path of weakness within it to facilitate peeling or stripping of the insulation shield for splicing or terminating the cable.

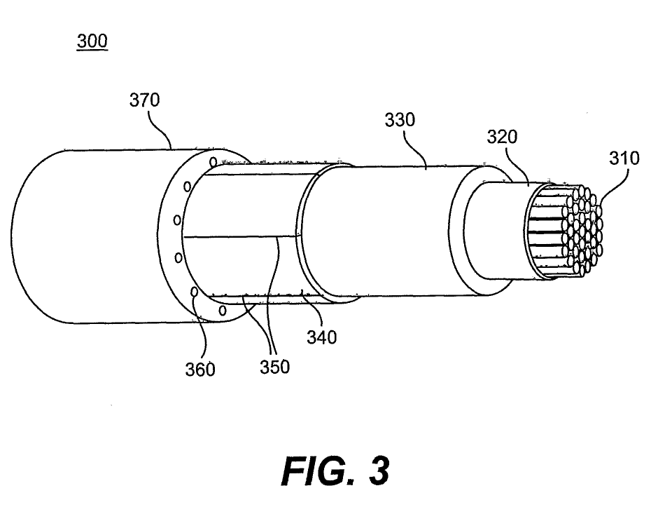

As embodied herein and generally disclosed in FIG. 3, cable 300 includes a conducting element 310. Conductors 310 are normally either solid or stranded. Preferably, conductors 310 are made of copper, aluminum or aluminum alloy.

The cable core also includes a conductor shield 320 that surrounds the conducting element 310. Conductor shield 320 is made of a semiconducting material the polymeric base of which is preferably chosen from ethylene vinyl acetate (EVA), ethylene ethyl acetate (EEA), ethylene methyl acetate (EMA), ethylene propylene rubber (EPR), ethylene-butadiene acetate, chlorosulfonated polyethylene (CSPE), polyethylene (PE).

Insulation layer 330 surrounds conductor shield 320. Insulation 330 is typically extruded and provides electrical insulation between conductor 310 and the closest electrical ground, thus preventing an electrical fault. One of ordinary skill in the art would recognize that the insulation layer 330 may comprise a cross-linked or non-cross-linked polymeric composition having electrical insulating properties. Examples of such insulation compositions for medium-voltage cables are: crosslinked polyethylene, ethylene propylene rubber, polyvinyl chloride, polyethylene, ethylene copolymers, natural rubber. An exemplary thickness for insulation layer 330 is 3 to 30 mm.

Insulation shield 340 is provided about insulation 330. The insulation shield 340 is usually made of an extruded semiconducting layer, although insulation shield 340 may alternatively be non-conducting. Insulation shield 340 and conductor shield 320 are used for electrical stress control providing for more symmetry of the electric fields within cable 300. Preferably, the insulation shield comprises a polymeric material chosen from ethylene vinyl acetate (EVA), ethylene ethyl acetate (EEA), ethylene methyl acetate (EMA), ethylene propylene rubber (EPR), ethylene butadiene acetate, chlorosulfonated polyethylene (CSPE), polyethylene (PE).

The thickness of insulation shield 340 may vary depending on the power cable type and application. As one example, in the case of medium voltage power cables, the insulation shield thickness may range from 0.5 to 2 mm.

Insulation shield 340 is typically an extruded material that is mechanically adhered to, yet removable from, insulation layer 330. The mechanical adherence advantageously minimizes any partial discharge that may otherwise occur between insulation layer 330 and insulation shield 340. As discussed further below, in the case of medium-voltage power cables, the mechanical adherence typically may be broken with a force ranging from 3 to 24 pounds.

As shown in FIG. 3, a plurality of electrically conductive strands 360, or concentric neutral elements, are located exterior to insulation shield 340. The concentric neutrals 360 serve as a neutral return current path in the case of fault conditions and must be sized accordingly. The elements 360 are preferably arranged concentrically around the axis of cable 300 and are twisted helically along its length. Neutral elements 360 are typically copper wires. Although most conventional concentric-neutral cables have neutral wires ranging in size from #14 AWG to #8 AWG (about 1.63 to 3.26 mm), neutral elements 360 may have any practical size, such as from #24 AWG to #8 AWG (about 0.51 to 3.26 mm). Alternatively, they may range in size collectively from about 5000 circular mils per inch of insulated core diameter to the full size of conductor 310. They also may be configured as flat straps or other non-circular shapes as the implementation permits.

Though not shown, a metallic shield may be employed instead of concentric neutrals 360. The metallic shield can be a-tape of desired conductive material, such as copper or aluminum, which is longitudinally folded or spirally twisted to form a circumferentially and longitudinally continuous layer. Preferably, the metal shield is corrugated.

Outer jacket 370 surrounds insulating shield 340 and forms the exterior of cable 300. Outer jacket 370 comprises a polymeric material and may be formed through pressure extrusion. Outer jacket 370 serves to protect the cable from environmental, thermal, and mechanical hazards and substantially encapsulates concentric neutral elements 360. When extruded, outer jacket 370 flows over semiconducting insulation shield 340 and surrounds neutral elements 360. The thickness of outer jacket 370 results in an encapsulated sheath that stabilizes neutral elements 360, maintains uniform neutral spacing for current distribution, and provides a rugged exterior for cable 300. While the polymeric material of the jacket flows around elements 360, the elements typically maintain a sufficient electrical contact with shield 340, such that the jacket may not entirely surround elements 360.

Outer jacket 370 may comprise an expanded polymeric material, which is produced by expanding (also known as foaming) a known polymeric material to achieve a desired density reduction. The expanded polymeric material of the jacket can be selected from the group comprising: polyolefins, copolymers of different olefins, unsaturated olefin/ester copolymers, polyesters, polycarbonates, polysulphones, phenolic resins, ureic resins, and mixtures thereof. Examples of preferred polymers are: polyvinyl chlorides (PVC), ethylene vinyl acetates (EVA), polyethylene (categorized as low density, linear low density, medium density and high density), polypropylene, and chlorinated polyethylenes.

As generally illustrated in FIG. 3, insulation shield 340 of cable 300 includes at least one path of weakness 350 along a length of the cable. The path of weakness may comprise any means known in the art for weakening the material strength of insulation shield 340, thereby facilitating the separation of insulation shield 340 into multiple longitudinal pieces. In a preferred embodiment, the at least one path of weakness is a score line or groove. Groove 350 may have any shape or dimension and serves to provide a path where the thickness of the insulation shield is less than the thickness of the shield elsewhere.

Groove 350 should extend deeply enough into insulation shield 340 to permit separation of the insulation shield along the groove but not so deeply as to pass entirely through insulation shield 340. The depth of groove 350 will depend in large measure on the thickness and material of insulation shield 340. Regardless of the material type and thickness, at least some insulation shield material should remain at the bottom of groove 350 to separate groove 350 from insulation layer 330. Preferably, at least 1 mil of the insulation shield material remains at the base of groove 350. In particular, a thickness of insulation shield 340 between a bottom of the at least one groove 350 and the outer surface of insulation layer 330 should be about 1-15 mils. More particularly, a thickness of insulation shield 340 between a bottom of the at least one groove 350 and the outer surface of insulation layer 340 may be about 5-10 mils.

The path of weakness 350 may have any width consistent with the goal of permitting separation of the insulation shield along the path. Preferably, groove 350 has a width within the range of one-half inch to one inch.

At least one path of weakness 350 traverses a path in a direction along the length of cable 300. As shown in FIG. 3, the paths of weakness 350 may be essentially straight lines parallel with the axis of cable 300. Within the spirit of the present invention, a single groove or multiple grooves 350 may be used, and multiple grooves may be separated by any circumferential distance desired for a particular application. In one example as shown in FIG. 3, multiple grooves 350 are spaced equally apart around the circumference of cable 300.

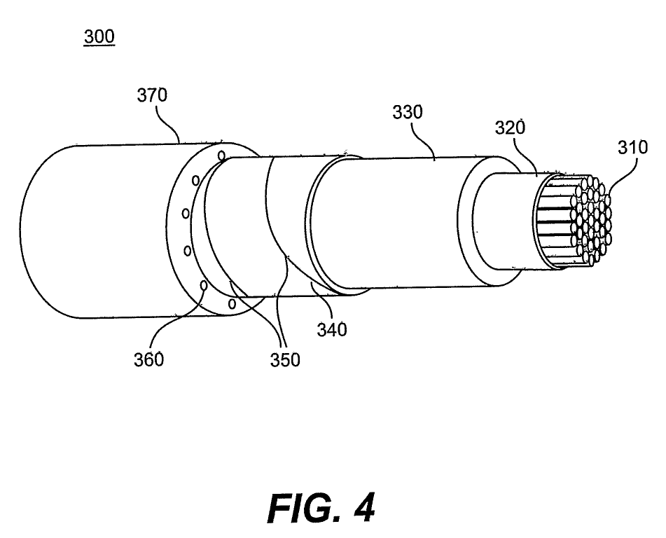

Alternatively, as shown in FIG. 4, paths of weakness 350 may form a spiral around insulation shield 340 in a substantially helical pattern. Again, if multiple grooves 350 are employed, any desired distance may separate them. In the example of FIG. 4, helical grooves 350 are essentially equidistant apart around the circumference of insulation shield 340. The at least one helical groove 350 of FIG. 4 may be applied at any angle. The helical angle (A) may be determined, for example, by the following formula:

$$Cos A = \frac{W}{π ( D - d )} ;$$

where:

A is the helical angle;

W is the spacing between scores;

D is the diameter of the insulation shield; and

d is the depth of the score.

At least one path of weakness 350 preferably extends continuously along the entire length of cable 350. In this manner, groove 350 is available to assist in stripping insulation shield 340 at any point along the cable's length, as discussed below. Groove 350 needs not traverse the entire length of cable 300, however, and needs not do so continuously. For example, at least path of weakness 350 may extend along only a portion of the length of cable 300. As well, a series of grooves 350 unconnected to each other (not shown), as with a series of line segments, may be arranged to provide an at least one groove at all points along the axis of cable 300.

Although embodiments have been described where the at least one path of weakness is a groove or score, other mechanisms for weakening the material strength of the insulation shield may alternatively be used with in the scope of the present invention. For instance, a ripcord or other release element (not shown) may be embedded within insulation layer 340. In doing so, care should be taken to ensure that the element be embedded within insulation shield 340. Placement of material between the insulation-shield and the insulation layer in a medium-voltage power cable can lead to detrimental partial discharge.

One possible embodiment for a ripcord is a collection of high tensile-strength fibers embedded in a matrix material. Suitable matrix materials may be one of the co-extrusion materials described below. The fibers could be placed into the insulation shield during cable extrusion by way of the extrusion tooling.

Other possibilities for a path of weakness in insulation shield 340 (not shown) may include tape or other material co-extruded with the insulation shield. As explained in more detail below, insulation shield is typically applied via extrusion. During this process, a material being dissimilar in strength to insulation shield 340 and yet compatible with insulation layer 330 may be co-extruded in the path of weakness. Such materials may include, for example, maleic anhydride modified ethylene vinyl acetates (EVA), and modified copolymer formulations of ethylene vinyl acetates (EVA), ethylene acrylate acetates (EEA), ethylene propylene rubber (EPR) ethylene butadiene acetates (EMA, chlorosulfonated polyethylene (CSPE) and polyethylene (PE).

By being dissimilar, it is meant that the material in the path of weakness has either a greater or lesser material bond strength than the material for insulation shield 340. The difference in bond strength between the materials will facilitate their separation when an upward force is applied to insulation shield 340, as explained below.

Where the at least one path of weakness includes more than a groove or score, it may be arranged to satisfy several conditions within the discretion of those skilled in the art. For instance, the material contributing to the weakness may be immiscible with insulation shield 340, being either stronger or weaker structurally than the insulation without leaving a void. Alternatively, the material contributing to the weakness may be miscible with insulation shield 340 and bond with it. In this instance, the material could be significantly weaker mechanically than the insulation shield, facilitating separation of the shield by a lineman.

As another option, the material contributing to the weakness could be significantly stronger mechanically than insulation shield 340, being either miscible or immiscible with the insulation. The material in this arrangement would function more closely like a conventional ripcord in a cable jacket.

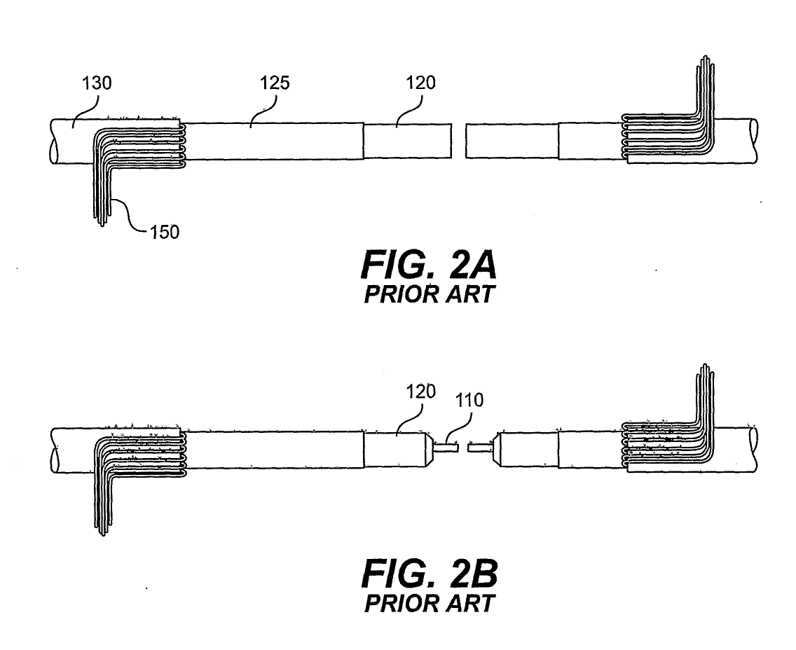

In operation, cable 300 provides an enhanced structure for stripping insulation shield 340 in splicing or terminating the cable. In stripping cable 300, an installer may first remove jacket 370 in a conventional manner and pull back concentric neutrals 360 to expose insulation shield 340, as shown in FIG. 2A. At least one path of weakness 350 in insulation shield 340 provides a channel for splitting and separating insulation shield 340 without the need for specialized tools.

In the field, a user may remove the insulation shield by applying a force, for example, using his hands or an apparatus, to pull the insulation shield away from the cable assembly along the path of weakness. By grasping a portion of insulation shield 340 at the end of cable 300, the shield may be pulled away from insulation layer 330 with manual force. Typically, a force of 3-24 lbs. will separate the two layers if they have been formed by co-extrusion. Pulling a portion of shield 340 outwardly from insulation layer 330 will cause shield to separate along at least one path 350 and form multiple portions bounded by, for example, the one or more grooves. If it is desired to completely remove shield 340 from cable 300, a single radial “ring” score may be made circumferentially around shield 340 at the desired location after the portions are selectively pulled back from insulation layer 330. The ring score may be made using any desired means, such as with conventional splicing tools commonly known in the art. The installer may then continue splicing the cable by cutting and removing insulation layer 330 and conductor shield 320 in the standard manner practiced in the field.

Preferably, paths of weakness, such as grooves 350, should be formed in insulation shield 340 in a manner to enable compliance with applicable industry standards for insulation removal, for example, AEIC CS8-00, a Field Strippability test. This test requires that two parallel cuts be made down toward the insulation with a ½± 1/32 inch (13±1 mm) separation with a scoring tool designed to remove the insulation shield in strips parallel to the cable axis. The scoring tool should be set at a depth not to exceed 1 mil (0.03 mm) less than the specified minimum point thickness of the insulation shield. Pulling force measurements are not required for this test. The insulation shield strip is to be removed by pulling the insulation shield away from the insulation at a speed of approximately ½-inch (13 mm) per second. The entire pull is made at an angle of approximately 90° to the cable axis. The total length of the pull is a minimum of 12 inches (300 mm). To pass the test, the insulation shield should be removable without tearing or leaving residual conductive material on the insulation surface.

Consistent with the principles of the present invention, an electrical power cable having improved strippability may be manufactured following several extrusion steps. These steps may include providing a cable core including at least one conductive element, applying a semiconducting conductor shield around the core, providing an insulation layer around the conductor shield, extruding an insulation shield around the insulation layer, extruding an insulation shield around the insulation layer, imparting a path of weakness within the insulation shield along a length of the cable, providing a metallic shield around the insulation shield and extruding an outer protective jacket.

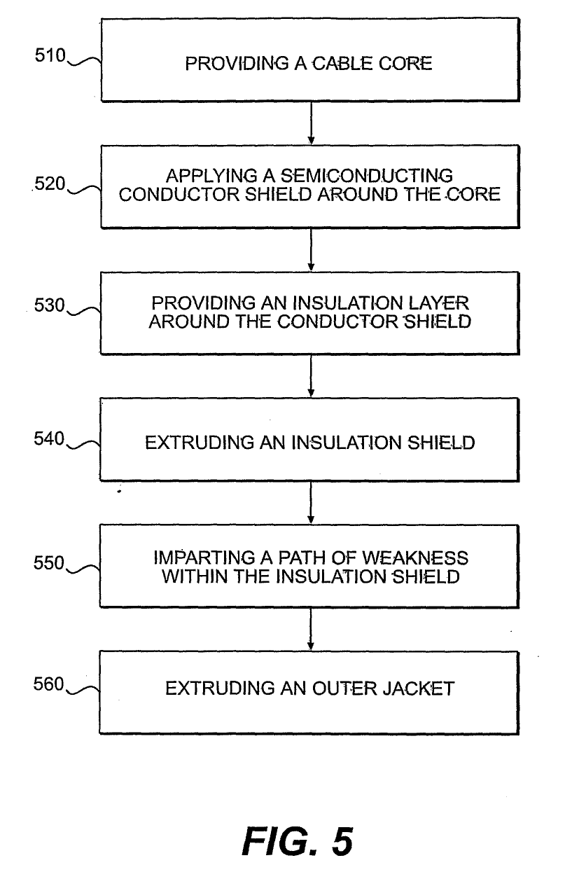

As embodied herein, a basic process for forming cable 300 is generally described in the flowchart of FIG. 5. The first step 510 of providing a cable core includes the conventional processes of forming an electrical conductor, possibly through stranding multiple wires into a conductor bundle 310. Applying 520 a semiconducting conductor shield around the core, providing 530 an insulation layer, and extruding 540 an insulation shield around the insulation layer may also involve techniques well known in the art. Each of the steps 520, 530, and 540 may be performed sequentially. That is, conductor shield 320 may be first applied or extruded over cable core 310, followed by the application of insulation layer 330, and then the extrusion of insulation shield 340.

Alternatively, one or more of steps 520, 530, and 540 may be performed simultaneously. That is, conductor shield 320 and insulation layer 330 may be co-extruded with insulation shield 340 being added over them. Alternatively, all three layers 320, 330, and 340 may be co-extruded in a single pass using a triple extruded head.

Imparting a path of weakness 550 in the insulation shield along the length of the cable may involve etching or cutting a path in the exterior of insulation shield 340 using any convenient implement. Preferably, one or more grooves or scores may be made using one or more blades. The blades should be capable of producing smooth and clean scores in the insulation shield, simulating the type of cut that would be made in the field by a user during preparation of the cable for splicing or termination. Razor-type blades are one example. In at least one embodiment, each blade should be capable of being set and locked in a guide at a predetermined score depth setting. However, even when set in position, the blades may also be spring loaded in the apparatus so as to allow for some movement of the cable due to the natural movements, and vibrations that are typical in such scoring operations.

More particularly, scoring 550 may involve passing the partially formed cable through an apparatus, wherein blades are contained within guides that can run along the outer surface of the cable, ensuring that the desired scoring depth is achieved. The blades may be adjustable on the guides to allow for different cable sizes and different score depths and types.

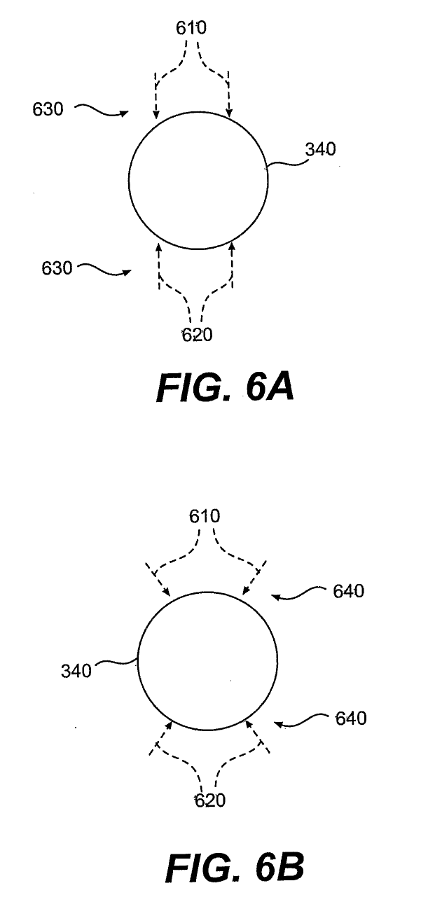

FIGS. 6A and 6B illustrate exemplary setups for providing scoring insulation layer 340. In these arrangements, blades 610 and 620 should remain stationary as the cable passes through the scoring apparatus. In FIG. 6A, two pairs of blades 610 and 620 are positioned in parallel, as depicted at 630. FIG. 6B shows another embodiment where pairs of blades 610 and 620 may be configured at an angle to each other, as depicted at 640. In this angled orientation, the blades score insulation shield 340 in a manner that minimizes tearing of the shield outside of groove 350 when the installer peels away the shield. The orientation angle in FIG. 6B may be such that the blades cut one or more grooves 350 that are substantially perpendicular to the surface of insulation shield 340. Although FIGS. 6A and 6B illustrate orientations-comprising four blades, any number of blades may be used at any specified spacing. In one example, blades 610 and 620 may be spaced about 0.5 inches apart.

A prescoring apparatus useful for producing helical scores will comprise one or more blades and guides, similar to the longitudinal scoring apparatus. However, in contrast to the stationary blades used to produce longitudinal scores, the blades in a helical scoring apparatus may rotate around the circumference of the cable as the cable passes through the apparatus. As in the longitudinal scoring apparatus, the blades may be adjusted to accommodate different cable sizes and scoring depths.

Alternatively, the scores on the insulation layer 340 are obtained during extrusion thereof. In other words, the insulation material is made to pass through a die assembly that is provided with protrusions suitably arranged to form scores on the insulation layer 340.

Alternatively, imparting a path of weakness 550 of FIG. 5 may involve co-extruding a material dissimilar to the insulation shield longitudinally along the cable within the insulation shield or embedding a release layer or ripcord within the shield. Where the material is significantly stronger than the insulation layer, such as a ripcord, the material may be placed into the insulation during extrusion of the insulation by way of extrusion tooling, rather than by co-extrusion.

Finally, a metallic shield and a jacket 560 in FIG. 5 are provided to the cable according to any technique known in the art.

By way of non-limiting illustration, two exemplary cables denoted Cables 1 and 2 were prepared with extruded insulation shields. Cable 1 was a 1/C #1/0 AWG 19 wire stranded aluminum conductor cable rated at 15 kV. As is readily known in the field, 1/C designates a single conductor cable, #1/0 AWG denotes the conductor size according to the American Wire Gauge standards, and 19 indicates the number of wires that were stranded together to make up the total area of the 1/0 AWG conductor. Cable 1 had a nominal insulation thickness of 175 mils, an insulation shield minimum thickness anticipated to be 30 mils, and an actual insulation minimum thickness of 31 mils.

Cable 2 was a 1/C 1000 kcm 61 wire stranded aluminum conductor cable rated at 25 kV. Again, 1/C indicates a single conductor-cable, 1,000 kcm denotes the conductor size as 1,000 thousand circular mils (1,000,000 circular mils), and 61 designates a stranding of 61 individual wires. Cable 2 had a nominal insulation thickness of 260 mils, an insulation shield minimum thickness anticipated to be 40 mils, and an actual insulation minimum thickness of 42 mils.

For each cable, two ½-inch longitudinal cuts were made spaced 180° apart. Each cut was made perpendicular to the insulation shield surface axis with razor type blades locked into the prescoring apparatus. Cables 1 and 2 were prescored to depths of 2, 5, 7, 10, and 15 mils, as measured from the insulation surface.

Prescored Cables 1 and 2 were subjected to final electrical withstand and partial discharge tests as required by AEIC CS8-00 and ICEA/ANSI S-94-649-2000 to ensure that the cables were electrically sound and the prescored insulation shield maintained a good bond with the underlying insulation. Both cables met the requirements for each test. Cable 1 had AC Withstand of 35 kV for 5 minutes (35 kV is 4 times the normal operating voltage to ground), and partial discharge of less than 5 pico-couloumbs at 35 kV AC. Cable 2 had AC Withstand of 52 kV for 5 minutes (52 kV is 4 times the normal operating voltage to ground), and partial discharge of less than 5 pico-coloumbs at 52 kV AC.

Prescored cables 1 and 2 were subjected to Field Strippability test in accordance with AEIC CS8-00. For each cable and each predetermined score depth, four 18-inch samples were taken for the stripping test. Two stripping tests were conducted per sample. The total length of pull for each test was a minimum of 12 inches.

To conduct the strippability test, each cable was horizontally placed and fixed into an Instron Tensile Testing Machine. The prescored edge was lifted and placed between two clamps set perpendicular to the horizontal sample to obtain a pull at an angle of 90° to the cable axis. The pulling rate was preset to ½-inch per second. Each pull was conducted until the strip was removed for at least 12 inches or until tearing occurred in the insulation shield other than at the groove lines.

The following tables report the results for the strippability tests. The various grooves or scores are reported in terms of their depth from the surface of the insulation shield and distance between the bottom of the groove and the outer surface of the underlying insulation layer. Tears refer to separation or ripping of the insulation shield other than within the path of the grooves.

TABLE I
Cable 1: Field Strippability Test at Room Temperature

Depth of Longitudinal Score (mils)/
Distance from Insulation (mils)

| | 29/2 | 26/5 | 24/7 | 21/10 | 16/15 |
|---|---|---|---|---|---|
| Number of Tears | 0 of 8 | 0 of 8 | 2 of 8 | 6 of 8 | 8 of 8 |
| out of Eight Pull | | | | | |
| Tests | | | | | |

TABLE II
Cable 2: Field Strippability Test at Room Temperature

Depth of Longitudinal Score (mils)/
Distance from Insulation (mils)

| | 40/2 | 37/5 | 35/7 | 32/10 | 27/15 |
|---|---|---|---|---|---|
| Number of Tears | 0 of 8 | 0 of 8 | 2 of 8 | 5 of 8 | 8 of 8 |
| out of Eight Pull | | | | | |
| Tests | | | | | |

These cables, as with cable 300 disclosed herein, provide enhanced structure for improving strippability of electrical power cables. With insulation shields having at least one path of weakness, the present cables enable installers to prepare the cable for splicing or termination with decreased use of specialized tools and with decreased risk of nicking or cutting the underlying insulation layer.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An electrical power cable, comprising:
at least one conductive element;
an insulation layer located in a position radially external to the at least one conductive element and having an outer surface;
an insulation shield surrounding the insulation layer and contacting the outer surface, the insulation shield having at least one path of weakness along a length of the cable configured to facilitate longitudinal stripping of the insulation shield; and
a jacket surrounding the insulation shield.

2. The cable of claim 1, further comprising-concentric neutral wires embedded in the jacket.

3. The cable of claim 1, further comprising a conductor shield surrounding the at least one conductive element.

4. The cable of claim 3, wherein the insulation layer surrounds the conductor shield.

5. The cable of claim 1, wherein the insulation shield has a thickness other than in the at least one groove ranging from 0.5 to 2 mm.

6. The cable of claim 1, wherein the at least one path of weakness is a groove.

7. The cable of claim 1, wherein the thickness of the insulation shield between the bottom of the at least one groove and the outer surface of the insulation layer is about 1-15 mils.

8. The cable of claim 7, wherein the thickness of the insulation shield between the bottom of the at least one groove and the outer surface of the insulation layer is about 2-10 mils.

9. The cable of claim 1, wherein the at least one path of weakness extends continuously along the entire length of the cable.

10. The cable of claim 1, wherein the at least one path is substantially straight and parallel to the axis of the cable.

11. The cable of claim 1, wherein the at least one path is substantially helical around the axis of the cable.

12. The cable of claim 11, wherein the substantially helical path has a helical angle A determined by the following formula:
$$Cos A = \frac{W}{π ( D - d )} ;$$
wherein:
W is the spacing between scores;
D is the diameter of the insulation shield; and
d is the depth of the more than one score lines.

13. The cable of claim 1, wherein the at least one path of weakness is a ripcord.

14. The cable of claim 1, wherein the at least one path of weakness is a release element embedded in the insulation shield.

15. A method for producing an electrical power cable having improved strippability, comprising:
providing at least one conductive element;
providing an insulation layer in a position radially external to the at least one conductive element;
extruding an insulation shield around the insulation layer;
imparting a path of weakness within the insulation shield along a length of the cable; and
extruding an outer jacket surrounding the scored insulation shield.

16. The method of claim 15, further comprising applying a conductor shield around the at least one conductive element.

17. The method of claim 15, wherein the insulation layer is provided around the conductor shield.

18. The method of claim 15, wherein the applying the conductor shield, the providing the insulation layer, and the extruding the insulation shield are performed simultaneously through co-extrusion.

19. The method of claim 15, wherein the imparting a path of weakness within the insulation shield occurs along the entire length of the cable.

20. The method of claim 15, wherein the imparting a path of weakness within the insulation shield comprises scoring the insulation shield to a depth of about 1-15 mils radially above the insulation layer.

21. The method of claim 15, wherein the imparting a path of weakness within the insulation shield comprises scoring the insulation shield to a depth of about 2-10 mils radially above the insulation layer.

22. The method of claim 15, wherein the imparting a path of weakness within the insulation shield comprises moving the cable longitudinally, before extrusion of the jacket, through at least one-blade positioned to cut into an exterior surface of the insulation shield.

23. The method of claim 22, wherein the at least one blade comprises two blades arranged substantially in parallel to each other.

24. The method of claim 22, wherein the at least one blade-comprises two blades arranged at an angle to each other.

25. The method of claim 22, wherein the imparting a path of weakness within the insulation shield further comprises rotating the at least one blade around the circumference of the insulation shield.

26. The method of claim 15, wherein the imparting a path of weakness within the insulation shield comprises extruding the insulation shield through a die assembly containing protrusions.

27. The method of claim 15, wherein the imparting at least one path of weakness comprises co-extruding a material dissimilar to the insulation shield along the at least one path.

28. The method of claim 15, wherein the imparting at least one path of weakness comprises imparting a ripcord into the insulation shield.
